(19) United States
(12) Patent Application Publication
(10) Pub. No.: US 2024/0042293 A1
(43) Pub. Date: Feb. 8, 2024

(54) GOLF CART WITH FRONT AND REAR WHEELS CAPABLE OF BEING UNFOLDED AND FOLDED SYNCHRONOUSLY

(71) Applicant: NINGBO WENTAI SPORT EQUIPMENT CO., LTD., Zhejiang (CN)

(72) Inventor: Sheng ZHANG, Zhejiang (CN)

(73) Assignee: NINGBO WENTAI SPORT EQUIPMENT CO., LTD., Zhejiang (CN)

(21) Appl. No.: 17/880,587

(22) Filed: Aug. 3, 2022

(51) Int. Cl. A63B 55/60; B62B 1/04

(52) U.S. Cl. CPC A63B 55/60; B62B 1/045; B62B 2202/404

(57) ABSTRACT

A golf cart with front and rear wheels capable of being unfolded and folded synchronously includes an upper frame module, a lower frame module, a handlebar module, a front wheel module and two rear wheel modules. The upper frame module is mounted on the lower frame module and is able to rotate with respect to the lower frame module under the action of force. The front wheel module is mounted at a front end of the lower frame module and is able to rotate with respect to the lower frame module under the action of force. The two rear wheel modules are mounted on left and right sides of a rear end of the lower frame module respectively. The handlebar module is mounted at an upper end of the upper frame module through a lock mechanism.

### BACKGROUND

### Technical Field

The invention relates to a golf cart, in particular to a golf cart with front and rear wheels capable of being unfolded and folded synchronously.

### Description of Related Art

Golf carts, as important equipment for golf, are generally foldable to be carried easily and to save space. The golf carts are folded when stored, and are unfolded when used.

Existing golf carts typically comprise an upper frame module, a lower frame module, a handlebar module, a front wheel module and two rear wheel modules, wherein the upper frame module is mounted on the lower frame module, the handlebar module is mounted on an upper portion of the upper frame module, the front wheel module is mounted at a front end of the lower frame module, and the two rear wheel modules are mounted on left and right sides of a rear end of the lower frame module respectively. The existing golf carts are easy to fold; however, the existing golf carts golf carts are only provided with one lock mechanism, so such golf carts can only be folded partially and still have a large size after being folded, thus being inconvenient to store. Golf carts that have a small size after being folded are generally provided with multiple lock mechanisms, and can be completely folded by unlocking the multiple lock mechanisms; however, the multiple lock mechanisms have to be unlocked to fold such golf carts and have to be locked to unfold such golf carts, so the unfolding and folding process is too complicated.

### SUMMARY

The technical issue to be settled by the invention is to provide a golf cart with front and rear wheels capable of being unfolded and folded synchronously. The golf cart is easy to unfold and fold, and a frame is space saving, compact, small in size and convenient to store after being folded.

The technical solution adopted by the invention to settle the above technical issue is as follows: a golf cart with front and rear wheels capable of being unfolded and folded synchronously comprises an upper frame module, a lower frame module, a handlebar module, a front wheel module and two rear wheel modules, wherein the upper frame module is mounted on the lower frame module and is able to rotate with respect to the lower frame module under the action of force, the front wheel module is mounted at a front end of the lower frame module and is able to rotate with respect to the lower frame module under the action of force, the two rear wheel modules are mounted on left and right sides of a rear end of the lower frame module respectively, and the handlebar module is mounted at an upper end of the upper frame module through a lock mechanism; when the lock mechanism is locked, the handlebar module is fixed to the upper frame module; when the lock mechanism is unlocked, the handlebar module is able to rotate to be folded with respect to the upper frame module; a connecting-rod link mechanism is arranged between the upper frame module, the lower frame module, the front wheel module and the two rear wheel modules; and when the upper frame module is folded towards the lower frame module, the front wheel module and the two rear wheel modules are driven by the upper frame modules through the connecting-rod link mechanism to be folded synchronously.

Each rear wheel module comprises an active connecting rod, a follower connecting rod and a rear wheel assembly, wherein the active connecting rod and the follower connecting rod are arranged in parallel and are spaced apart from each other, a lower end of the active connecting rod and a lower end of the follower connecting rod are rotatably mounted on the rear wheel assembly, and an upper end of the active connecting rod and an upper end of the follower connecting rod are rotatably mounted on the lower frame module; the connecting-rod link mechanism comprises a slider and a connecting-rod assembly, the slider is mounted on the lower frame module and is able to move forward and backward with respect to the lower frame module under the action of force, the connecting-rod assembly comprises a first connecting rod, a second connecting rod, a third connecting rod and a fourth connecting rod, the first connecting rod has an end rotatably mounted on the slider and an end rotatably mounted on the upper frame module, the second connecting rod has an end rotatably mounted on the slider and an end rotatably mounted on the active connecting rod of the rear wheel module on the left, the third connecting rod has an end rotatably mounted on the slider and an end rotatably mounted on the active connecting rod of the rear wheel module on the right, and the fourth connecting rod has an end rotatably mounted on the slider and an end rotatably mounted on the front wheel module; when the upper frame module is folded, the first connecting rod pushes the slider to move forward with respect to the lower frame module, the slider drives the second connecting rod, the third connecting rod and the fourth connecting rod to move synchronously, at this moment, the second connecting rod drives the active connecting rod of the rear wheel module on the left to move synchronously, the third connecting rod drives the active connecting rod of the rear wheel module on the right to move synchronously, the active connecting rod of each rear wheel module drives the corresponding follower connecting rod and the corresponding rear wheel assembly to synchronously move close to the lower frame module to be folded, and the fourth connecting rod pushes the front wheel module to rotate backward to be folded, so that the front wheel module and the two rear wheel modules are folded synchronously.

The front wheel module is mounted on the lower frame module through a joint assembly, the joint assembly comprises a main joint, a left joint, a right joint, a fixing pin and a connecting shaft, the main joint is fixed to a rear end of the front wheel module, the left joint is located on a left side of the main joint, the right joint is located on a right side of the main joint, the left joint and the right joint are fixed to the front end of the lower frame module, the connecting shaft sequentially penetrates through the left joint, the main joint and the right joint to connect the left joint, the main joint and the right joint, the fourth connecting rod is connected to the main joint, a first elastic member is arranged between the left joint and the main joint and is connected to the main joint and the left joint, and a second elastic member is arranged between the right joint and the main joint and is connected to the main joint and the right joint. In this structure, the first elastic member and the second elastic member are used as power units; when the golf cart is in a folded state, the first elastic member and the second elastic member are compressed; and when the golf cart is unfolded, the first elastic member and the second elastic member restore to allow the front wheel module to be unfolded more easily.

The front wheel module is mounted on the lower frame module through a joint assembly, the joint assembly comprises a main joint, a left joint, a right joint, a fixing pin and a connecting shaft, the main joint is fixed to a front end of the lower frame module, the left joint is located on a left side of the main joint, the right joint is located on a right side of the main joint, the left joint and the right joint are fixed to a rear end of the front wheel module, the connecting shaft sequentially penetrates through the left joint, the main joint and the right joint to connect the left joint, the main joint and the right joint, the fourth connecting rod is connected to at least one of the left joint and the right joint, a first elastic member is arranged between the left joint and the main joint and is connected to the main joint and the left joint, and a second elastic member is arranged between the right joint and the main joint and is connected to the main joint and the right joint. In this structure, the first elastic member and the second elastic member are used as power units; when the golf cart is in a folded state, the first elastic member and the second elastic member are compressed; and when the golf cart is unfolded, the first elastic member and the second elastic member restore to allow the front wheel module to be unfolded more easily.

The first elastic member and the second elastic member are torsion springs.

A third elastic member is arranged between the lower frame module and the upper frame module and is connected to the lower frame module and the upper frame module. In this structure, the third elastic member is used as a power unit; when the golf cart is in a folded state, the third elastic member is compressed; and when the golf cart is unfolded, the third elastic member restores to allow the upper frame module to be unfolded more easily.

The third elastic member is a torsion spring.

A buckle is disposed on an upper portion of an upper frame module and is connected to the upper frame module through a fixing bolt, the fixing bolt penetrates through the buckle and the upper frame module and is able to swing along the fixing bolt with respect to the upper frame module under the action of force, the upper frame module and the buckle are connected through a fourth elastic member, a fixing clip is arranged on the lower frame module, the main joint, the left joint or the right joint, and after the front wheel module and the two rear wheel modules are synchronously folded, the buckle is clamped in the fixing clip to be fixed. In this structure, the buckle is clamped in the fixing clip to realize a stable connection after the golf cart is folded, so that the folding reliability is guaranteed.

Compared with the prior art, the invention has the following advantages: the connecting-rod link mechanism is arranged between the upper frame module, the lower frame module, the front wheel module and the two rear wheel modules; and when the upper frame module is folded towards the lower frame module, the front wheel module and the two rear wheel modules are driven by the upper frame modules through the connecting-rod link mechanism to be folded synchronously. According to the golf cart of the invention, the handlebar module is unfolded or folded separately, and then front and rear wheels are unfolded or folded synchronously, so the golf cart can be unfolded or folded through two steps, the unfolding and folding process is simple, and a frame is space saving, compact, small in size and convenient to store after being folded.

### BRIEF DESCRIPTION OF THE DRAWINGS

FIG. 1 is a front view of a golf cart with front and rear wheels capable of being unfolded and folded synchronously in an unfolded state according to the invention.

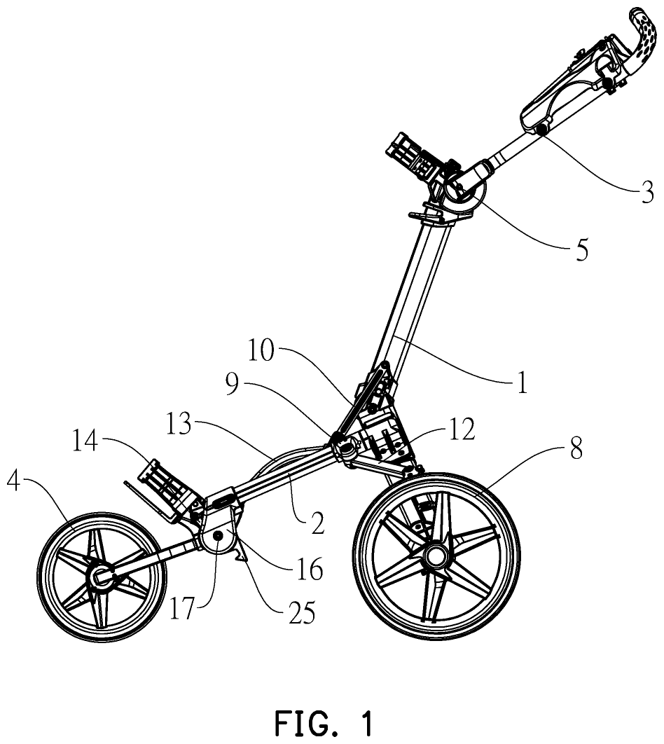

FIG. 2 is a three-dimensional view of the golf cart with front and rear wheels capable of being unfolded and folded synchronously in the unfolded state according to the invention.

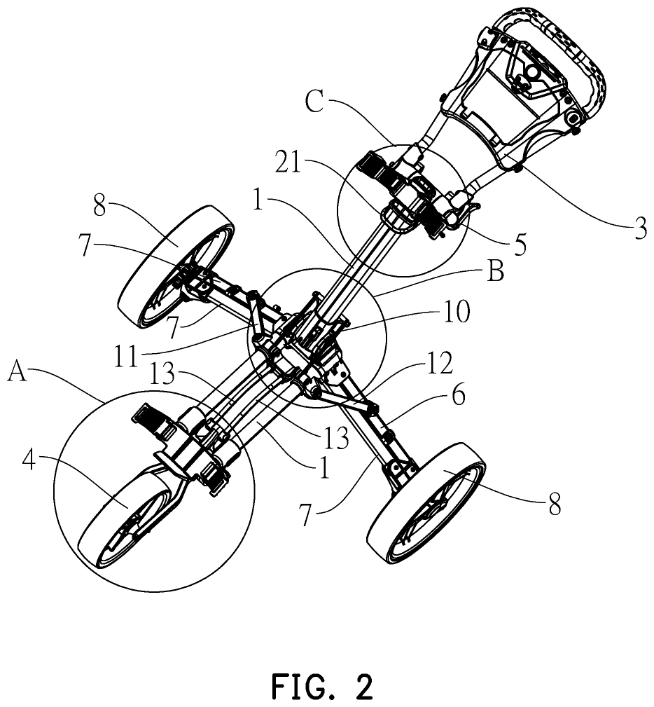

FIG. 3 is an exploded view of part A in FIG. 2.

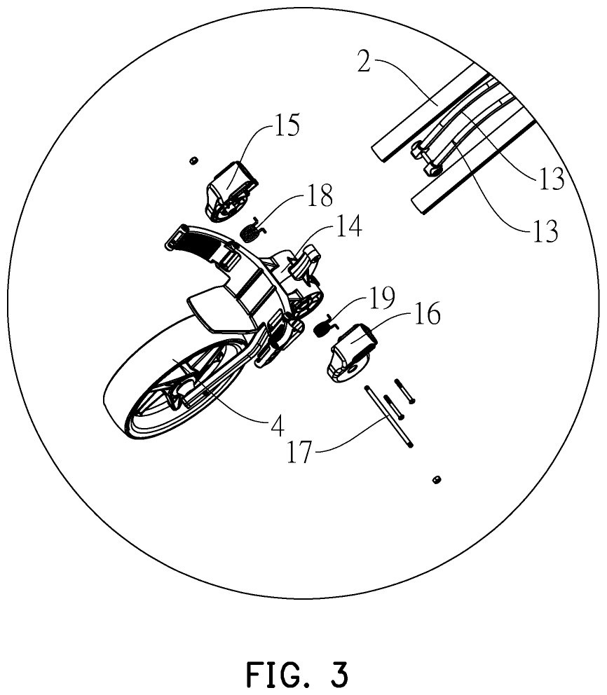

FIG. 4 is an exploded view of part B in FIG. 2.

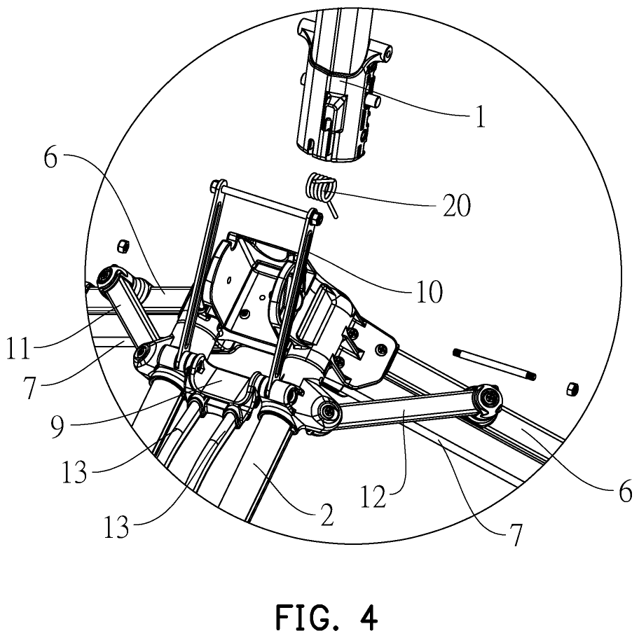

FIG. 5 is an exploded view of part C in FIG. 2.

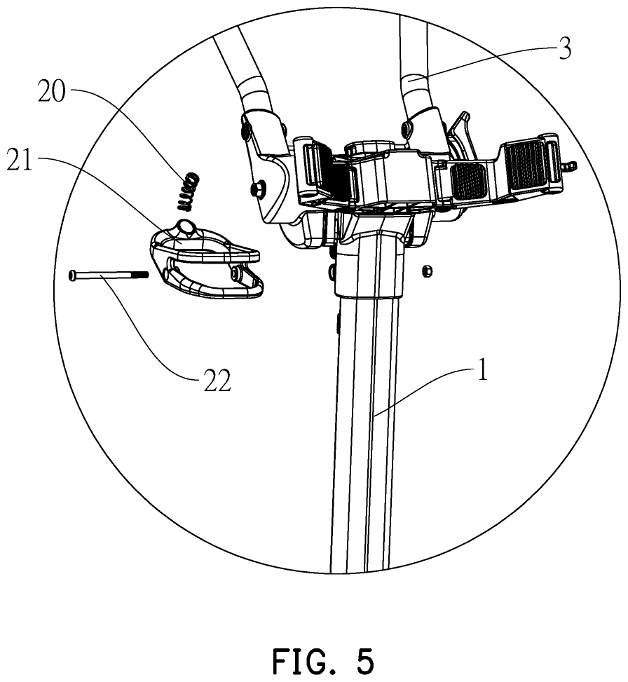

FIG. 6 is a partial sectional view of the golf cart with front and rear wheels capable of being unfolded and folded synchronously in a folded state according to the invention.

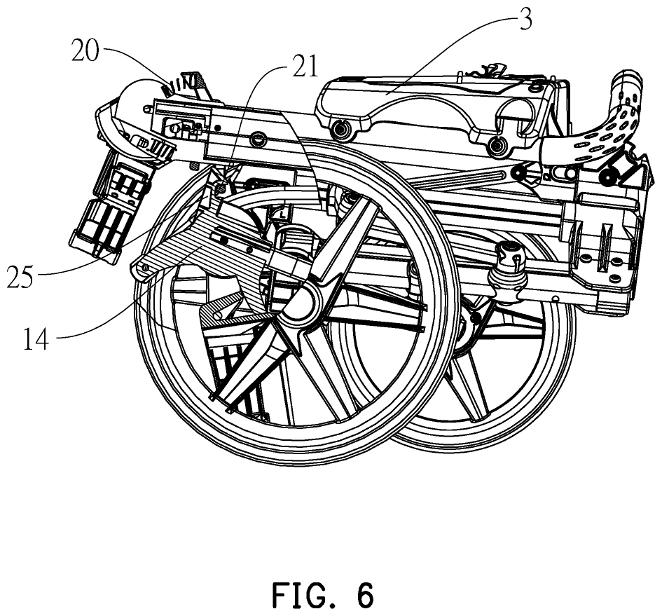

FIG. 7 is a first diagram of the folding process of the golf cart with front and rear wheels capable of being unfolded and folded synchronously according to the invention.

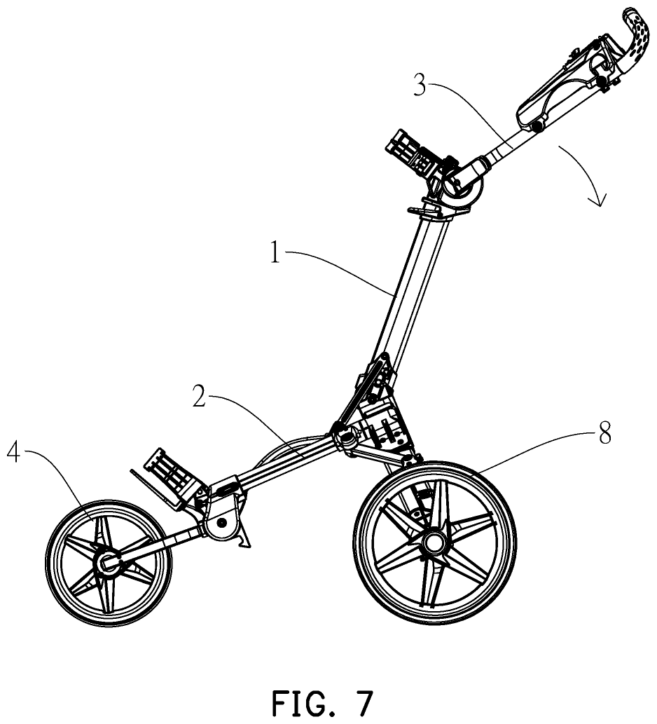

FIG. 8 is a second diagram of the folding process of the golf cart with front and rear wheels capable of being unfolded and folded synchronously according to the invention.

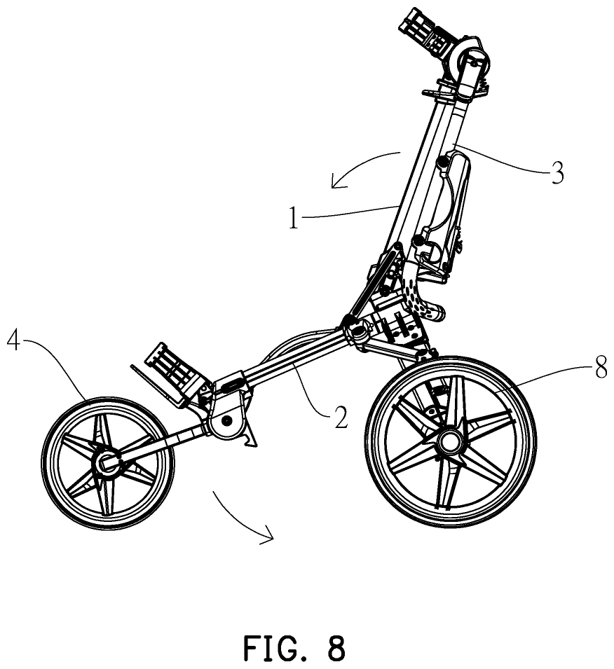

FIG. 9 is a third diagram of the folding process of the golf cart with front and rear wheels capable of being unfolded and folded synchronously according to the invention.

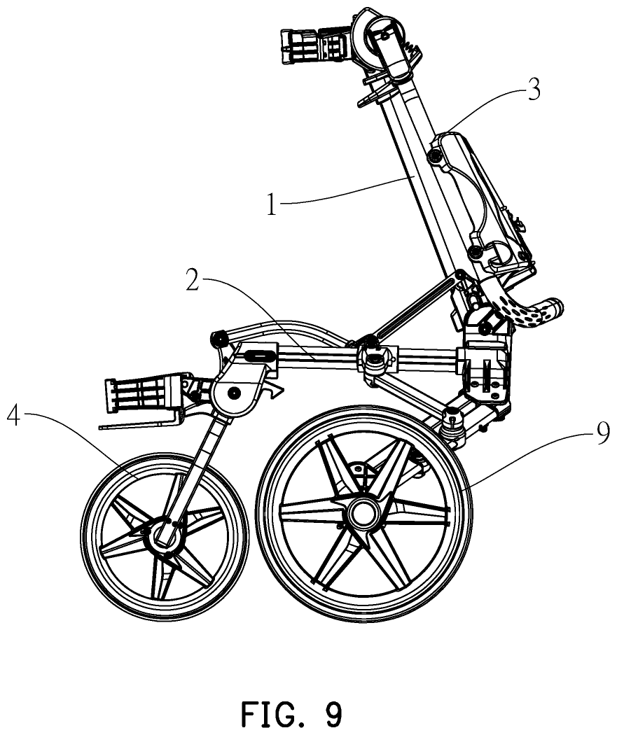

FIG. 10 is a fourth diagram of the folding process of the golf cart with front and rear wheels capable of being unfolded and folded synchronously according to the invention.

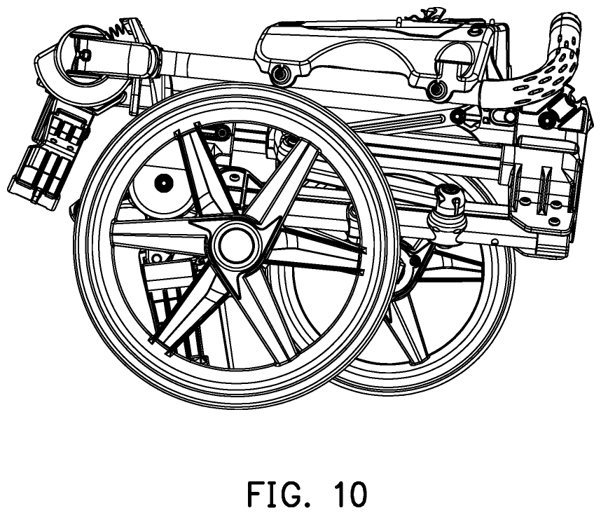

### DESCRIPTION OF THE EMBODIMENTS

The invention will be described in further detail below in conjunction with the accompanying drawings and embodiments.

Embodiment 1: as shown, a golf cart with front and rear wheels capable of being unfolded and folded synchronously comprises an upper frame module 1, a lower frame module 2, a handlebar module 3, a front wheel module 4 and two rear wheel modules, wherein the upper frame module 1 is mounted on the lower frame module 2 and is able to rotate with respect to the lower frame module 2 under the action of force, the front wheel module 4 is mounted at a front end of the lower frame module 2 and is able to rotate with respect to the lower frame module 2 under the action of force, the two rear wheel modules are mounted on left and right sides of a rear end of the lower frame module 2 respectively, and the handlebar module 3 is mounted at an upper end of the upper frame module 1 through a lock mechanism 5; when the lock mechanism is locked, the handlebar module 3 is fixed to the upper frame module 1; when the lock mechanism 5 is unlocked, the handlebar module 3 is able to rotate to be folded with respect to the upper frame module 1; a connecting-rod link mechanism is arranged between the upper frame module 1, the lower frame module 2, the front wheel module 4 and the two rear wheel modules; and when the upper frame module 1 is folded towards the lower frame module 2, the front wheel module 4 and the two rear wheel modules are driven by the upper frame modules 1 through the connecting-rod link mechanism to be folded synchronously.

In this embodiment, each rear wheel module comprises an active connecting rod 6, a follower connecting rod 7 and a rear wheel assembly 8, wherein the active connecting rod 6 and the follower connecting rod 7 are arranged in parallel and are spaced apart from each other, a lower end of the active connecting rod 6 and a lower end of the follower connecting rod 7 are rotatably mounted on the rear wheel assembly 8, and an upper end of the active connecting rod 6 and an upper end of the follower connecting rod 7 are rotatably mounted on the lower frame module 2; the connecting-rod link mechanism comprises a slider 9 and a connecting-rod assembly, the slider 9 is mounted on the lower frame module 2 and is able to move forward and backward with respect to the lower frame module 2 under the action of force, the connecting-rod assembly comprises a first connecting rod 10, a second connecting rod 11, a third connecting rod 12 and a fourth connecting rod 13, one end of the first connecting rod 10 is rotatably mounted on the slider 9, the other end of the first connecting rod 10 is rotatably mounted on the upper frame module 1, one end of the second connecting rod 11 is rotatably mounted on the slider 9, the other end of the second connecting rod 11 is rotatably mounted on the active connecting rod 6 of the rear wheel module on the left, one end of the third connecting rod 12 is rotatably mounted on the slider 9, the other end of the third connecting rod 12 is rotatably mounted on the active connecting rod 6 of the rear wheel module on the right, one end of the fourth connecting rod 13 is rotatably mounted on the slider 9, and the other end of the fourth connecting rod 13 is rotatably mounted on the front wheel module 4; when the upper frame module 1 is folded, the first connecting rod 10 pushes the slider 9 to move forward with respect to the lower frame module 2, the slider 9 drives the second connecting rod 11, the third connecting rod 12 and the fourth connecting rod 13 to move synchronously, at this moment, the second connecting rod 11 drives the active connecting rod 6 of the rear wheel module on the left to move synchronously, the third connecting rod 12 drives the active connecting rod 6 of the rear wheel module on the right to move synchronously, the active connecting rod 6 of each rear wheel module drives the corresponding follower connecting rod 7 and the corresponding rear wheel assembly 8 to synchronously move close to the lower frame module 2 to be folded, and the fourth connecting rod 13 pushes the front wheel module 4 to rotate backward to be folded, so that the front wheel module 4 and the two rear wheel modules are folded synchronously.

In this embodiment, the front wheel module 4 is mounted on the lower frame module 2 through a joint assembly, the joint assembly comprises a main joint 14, a left joint 15, a right joint 16 and a connecting shaft 17, the main joint 14 is fixed to a rear end of the front wheel module 4, the left joint 15 is located on a left side of the main joint 14, the right joint 16 is located on a right side of the main joint 14, the left joint 15 and the right joint 16 are fixed to the front end of the lower frame module 2, the connecting shaft 17 sequentially penetrates through the left joint 15, the main joint 14 and the right joint 16 to connect the left joint 15, the main joint 14 and the right joint 16, the fourth connecting rod 13 is connected to the main joint 14, a first elastic member 18 is arranged between the left joint 15 and the main joint 14 and is connected to the main joint 14 and the left joint 15, and a second elastic member 19 is arranged between the right joint 16 and the main joint 14 and is connected to the main joint 14 and the right joint 16.

In this embodiment, the first elastic member 18 and the second elastic member 19 are torsion springs.

In this embodiment, a third elastic member 20 is arranged between the lower frame module 2 and the upper frame module 1 and is connected to the lower frame module 2 and the upper frame module 1.

In this embodiment, the third elastic member 20 is a torsion spring.

In this embodiment, a buckle 21 is disposed on an upper portion of an upper frame module 1 and is connected to the upper frame module 1 through a fixing bolt 22, the fixing bolt 22 penetrates through the buckle 21 and the upper frame module 1 and is able to swing along the fixing bolt 22 with respect to the upper frame module 1 under the action of force, the upper frame module 1 and the buckle 21 are connected through a fourth elastic member 24, a fixing clip 25 is arranged on the lower frame module 2, the main joint 14, the left joint 15 or the right joint 16, and after the front wheel module 4 and the two rear wheel modules are synchronously folded, the buckle 21 is clamped in the fixing clip 25 to be fixed.

Embodiment 2: this embodiment is basically identical with Embodiment 1 and differs from Embodiment 1 in the following aspects: in this embodiment, the front wheel module 4 is mounted on the lower frame module 2 through a joint assembly, the joint assembly comprises a main joint 14, a left joint 15, a right joint 16 and a connecting shaft 17, the main joint 14 is fixed to the front end of the lower frame module 2, the left joint 15 is located on a left side of the main joint 14, the right joint 16 is located on a right side of the main joint 14, the left joint 15 and the right joint 16 are fixed to a rear end of the front wheel module 4, the connecting shaft 17 sequentially penetrates through the left joint 15, the main joint 14 and the right joint 16 to connect the left joint 15, the main joint 14 and the right joint 16, the fourth connecting rod 13 is connected to at least one of the left joint 15 and the right joint 16, a first elastic member 18 is arranged between the left joint 15 and the main joint 14 and is connected to the main joint 14 and the left joint 15, and a second elastic member 19 is arranged between the right joint 16 and the main joint 14 and is connected to the main joint 14 and the right joint 16.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A golf cart with front and rear wheels capable of being unfolded and folded synchronously, comprising an upper frame module, a lower frame module, a handlebar module, a front wheel module and two rear wheel modules, the upper frame module being mounted on the lower frame module and being able to rotate with respect to the lower frame module under the action of force, the front wheel module being mounted at a front end of the lower frame module and being able to rotate with respect to the lower frame module under the action of force, the two rear wheel modules being mounted on left and right sides of a rear end of the lower frame module respectively, the handlebar module being mounted at an upper end of the upper frame module through a lock mechanism; when the lock mechanism is locked, the handlebar module being fixed to the upper frame module; when the lock mechanism is unlocked, the handlebar module being able to rotate to be folded with respect to the upper frame module, wherein a connecting-rod link mechanism is arranged between the upper frame module, the lower frame module, the front wheel module and the two rear wheel modules; and when the upper frame module is folded towards the lower frame module, the front wheel module and the two rear wheel modules are driven by the upper frame modules through the connecting-rod link mechanism to be folded synchronously.

2. The golf cart with front and rear wheels capable of being unfolded and folded synchronously according to claim 1, wherein each said rear wheel module comprises an active connecting rod, a follower connecting rod and a rear wheel assembly, the active connecting rod and the follower connecting rod are arranged in parallel and are spaced apart from each other, a lower end of the active connecting rod and a lower end of the follower connecting rod are rotatably mounted on the rear wheel assembly, and an upper end of the active connecting rod and an upper end of the follower connecting rod are rotatably mounted on the lower frame module; the connecting-rod link mechanism comprises a slider and a connecting-rod assembly, the slider is mounted on the lower frame module and is able to move forward and backward with respect to the lower frame module under the action of force, the connecting-rod assembly comprises a first connecting rod, a second connecting rod, a third connecting rod and a fourth connecting rod, the first connecting rod has an end rotatably mounted on the slider and an end rotatably mounted on the upper frame module, the second connecting rod has an end rotatably mounted on the slider and an end rotatably mounted on the active connecting rod of the rear wheel module on a left, the third connecting rod has an end rotatably mounted on the slider and an end rotatably mounted on the active connecting rod of the rear wheel module on a right side, and the fourth connecting rod has an end rotatably mounted on the slider and an end rotatably mounted on the front wheel module; when the upper frame module is folded, the first connecting rod pushes the slider to move forward with respect to the lower frame module, the slider drives the second connecting rod, the third connecting rod and the fourth connecting rod to move synchronously, at this moment, the second connecting rod drives the active connecting rod of the rear wheel module on the left to move synchronously, the third connecting rod drives the active connecting rod of the rear wheel module on the right to move synchronously, the active connecting rod of each said rear wheel module drives the corresponding follower connecting rod and the corresponding rear wheel assembly to synchronously move close to the lower frame module to be folded, and the fourth connecting rod pushes the front wheel module to rotate backward to be folded, so that the front wheel module and the two rear wheel modules are folded synchronously.

3. The golf cart with front and rear wheels capable of being unfolded and folded synchronously according to claim 2, wherein the front wheel module is mounted on the lower frame module through a joint assembly, the joint assembly comprises a main joint, a left joint, a right joint, a fixing pin and a connecting shaft, the main joint is fixed to a rear end of the front wheel module, the left joint is located on a left side of the main joint, the right joint is located on a right side of the main joint, the left joint and the right joint are fixed to the front end of the lower frame module, the connecting shaft sequentially penetrates through the left joint, the main joint and the right joint to connect the left joint, the main joint and the right joint, the fourth connecting rod is connected to the main joint, a first elastic member is arranged between the left joint and the main joint and is connected to the main joint and the left joint, and a second elastic member is arranged between the right joint and the main joint and is connected to the main joint and the right joint.

4. The golf cart with front and rear wheels capable of being unfolded and folded synchronously according to claim 2, wherein the front wheel module is mounted on the lower frame module through a joint assembly, the joint assembly comprises a main joint, a left joint, a right joint, a fixing pin and a connecting shaft, the main joint is fixed to the front end of the lower frame module, the left joint is located on a left side of the main joint, the right joint is located on a right side of the main joint, the left joint and the right joint are fixed to a rear end of the front wheel module, the connecting shaft sequentially penetrates through the left joint, the main joint and the right joint to connect the left joint, the main joint and the right joint, the fourth connecting rod is connected to at least one of the left joint and the right joint, a first elastic member is arranged between the left joint and the main joint and is connected to the main joint and the left joint, and a second elastic member is arranged between the right joint and the main joint and is connected to the main joint and the right joint.

5. The golf cart with front and rear wheels capable of being unfolded and folded synchronously according to claim 3, wherein the first elastic member and the second elastic member are torsion springs.

6. The golf cart with front and rear wheels capable of being unfolded and folded synchronously according to claim 4, wherein the first elastic member and the second elastic member are torsion springs.

7. The golf cart with front and rear wheels capable of being unfolded and folded synchronously according to claim 2, wherein a third elastic member is arranged between the lower frame module and the upper frame module and is connected to the lower frame module and the upper frame module.

8. The golf cart with front and rear wheels capable of being unfolded and folded synchronously according to claim 3, wherein a third elastic member is arranged between the lower frame module and the upper frame module and is connected to the lower frame module and the upper frame module.

9. The golf cart with front and rear wheels capable of being unfolded and folded synchronously according to claim 4, wherein a third elastic member is arranged between the lower frame module and the upper frame module and is connected to the lower frame module and the upper frame module.

10. The golf cart with front and rear wheels capable of being unfolded and folded synchronously according to claim 7, wherein the third elastic member is a torsion spring.

11. The golf cart with front and rear wheels capable of being unfolded and folded synchronously according to claim 8, wherein the third elastic member is a torsion spring.

12. The golf cart with front and rear wheels capable of being unfolded and folded synchronously according to claim 9, wherein the third elastic member is a torsion spring.

13. The golf cart with front and rear wheels capable of being unfolded and folded synchronously according to claim 3, wherein a buckle is disposed on an upper portion of an upper frame module and is connected to the upper frame module through a fixing bolt, the fixing bolt penetrates through the buckle and the upper frame module and is able to swing along the fixing bolt with respect to the upper frame module under the action of force, the upper frame module and the buckle are connected through a fourth elastic member, a fixing clip is arranged on the lower frame module, the main joint, the left joint or the right joint, and after the front wheel module and the two rear wheel modules are synchronously folded, the buckle is clamped in the fixing clip to be fixed.

14. The golf cart with front and rear wheels capable of being unfolded and folded synchronously according to claim 4, wherein a buckle is disposed on an upper portion of an upper frame module and is connected to the upper frame module through a fixing bolt, the fixing bolt penetrates through the buckle and the upper frame module and is able to swing along the fixing bolt with respect to the upper frame module under the action of force, the upper frame module and the buckle are connected through a fourth elastic member, a fixing clip is arranged on the lower frame module, the main joint, the left joint or the right joint, and after the front wheel module and the two rear wheel modules are synchronously folded, the buckle is clamped in the fixing clip to be fixed.
